(19) United States
(12) Patent Application Publication
(10) Pub. No.: US 2017/0114929 A1
(43) Pub. Date: Apr. 27, 2017

(54) MULTILAYER TUBE, PARTICULARLY FOR FLUIDS

(71) Applicants: FLUOR TUBING B.V., Utrecht (NL); TUBIGOMMA DEREGIBUS S.R.L., Saccolongo (IT)

(72) Inventors: Andrea DEREGIBUS, Padova (IT); Alexander J. A. SOETERBROEK, Bosch En Duin (NL)

(21) Appl. No.: 15/299,246

(22) Filed: Oct. 20, 2016

(30) Foreign Application Priority Data
Oct. 26, 2015 (IT) 102015000065127

(51) Int. Cl. F16L 11/02; F16L 11/04

(52) U.S. Cl. CPC F16L 11/02; F16L 11/04

(57) ABSTRACT

A multilayer tube, particularly for fluids is provided with an internally hollow shape and includes a co-extruded sheath made of fluorinated polymers such as FEP, MFA, PFA, ECTFE and PTFE, located in the innermost layer. The sheath is constituted by an internal substrate made of non-pigmented virgin material and by an external substrate made of pigmented material.

### CROSS REFERENCE TO RELATED APPLICATIONS

This application is related to and claims the benefit of Italian Patent Application No. 102015000065127, filed on Oct. 26, 2015, the contents of which are herein incorporated by reference in their entirety.

### TECHNICAL FIELD

The present disclosure relates to a multilayer tube, particularly for fluids, which has applications in many and varied sectors, such as for example the food sector, the chemical sector, the pharmaceutical sector and the cosmetics sector.

### BACKGROUND

Nowadays the use is known of multilayer tubes constituted by a sheath, located in the innermost layer of the tube, which comes directly into contact with the fluid, by one or more intermediate reinforcement layers, and by an external covering layer.

It is also known to subject the outer surface of the inner sheath, made of fluorinated polymers such as FEP, MFA, PFA, ECTFE and PTFE, to a cementing process, a chemical process that renders the fluorinated polymer bondable by adhesive to other surfaces, which would otherwise not be possible because surface non-adhesiveness is one of its principal characteristics, in order to enable stable adhesion with the subsequent layer, generally made with organic and inorganic elastomers such as silicone.

The cementing process entails the coloring (generally dark brown) of the sheath; as a consequence the user who inspects the inside of the tube to check the cleaning thereof will observe a dark patina which is substantially unaesthetic and which conveys an impression of dirt.

In order to overcome the problem, it is known to mask the coloring by increasing the thickness of the sheath so that the dark patina is no longer visible to a user who may inspect the tube.

A drawback that arises in this known art consists in that the multilayer tube has a high mechanical rigidity that consequently limits its flexibility. Furthermore, such known art requires the use of a large quantity of material, which entails high costs.

A further solution is also known for preventing the user from seeing the dark patina, which consists of pigmenting the material with which the sheath is made, for example using titanium oxide to give it a white coloring.

A drawback that can arise in this known art consists in that, during the transition of the fluid inside the tube, an extraction could occur of the substances used to pigment the sheath, which would therefore be transferred to the fluid that flows inside the tube and is consequently in contact with the pigmented sheath, thus polluting the fluid.

### SUMMARY

The aim of the present disclosure is to eliminate the above mentioned drawbacks, by providing a multilayer tube, particularly for fluids, which makes it possible to preserve and maintain the characteristics of the fluid that flows inside it.

Within this aim, the present disclosure provides a multilayer tube that is flexible.

The disclosure further provides a multilayer tube that can be given a desired and optimal visual impact.

The disclosure also provides a multilayer tube that is structurally simple and low cost and can be made with the usual conventional plants.

These features which will become better apparent hereinafter are achieved by a multilayer tube, particularly for fluids, provided with an internally hollow shape, wherein the multilayer tube comprises a co-extruded sheath made of fluorinated polymers, located in the innermost layer and constituted by an internal substrate made of non-pigmented virgin material and by an external substrate made of pigmented material.

### BRIEF DESCRIPTION OF THE DRAWINGS

Further characteristics and advantages of the disclosure will become better apparent from the detailed description of a particular, but not exclusive, embodiment of the multilayer tube according to the disclosure, which is illustrated by way of non-limiting example in the accompanying drawings wherein:

FIG. 1 is a schematic perspective view of a multilayer tube in a first embodiment thereof;

FIG. 2 is a partial cross-section view of the sheath of FIG. 1; and

FIG. 3 is a schematic perspective view of the multilayer tube in a second embodiment thereof

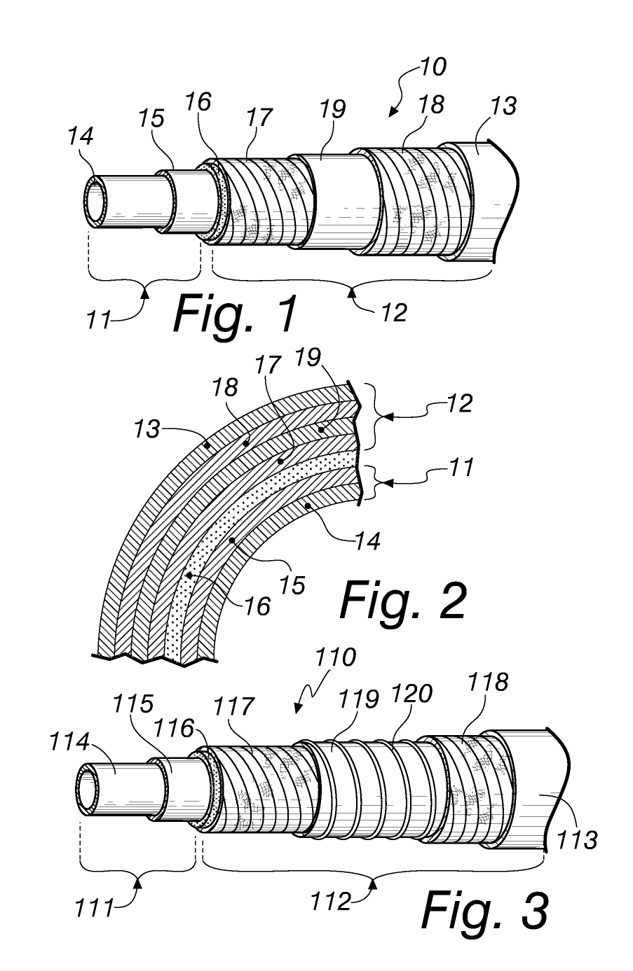

In the embodiments illustrated, individual characteristics shown in relation to specific examples may in reality be interchanged with other, different characteristics, existing in other embodiments.

### DETAILED DESCRIPTION OF THE DRAWINGS

With reference to the figures, the reference numeral 10, 110 generally designates a multilayer tube, particularly for fluids, provided with a cylindrical and internally hollow shape.

The multilayer tube 10, 110 is constituted by a sheath 11, 111, located in the innermost layer, which is adapted to be placed in direct contact with a fluid in transit; there are further one or more intermediate reinforcement layers 12, 112, which are arranged coaxial to the sheath 11, 111, and an external covering layer 13, 113, which is made of elastomeric material and is coaxial to the one or more reinforcement layers 12, 112.

The sheath 11, 111 is co-extruded and made of fluorinated polymers.

Such fluorinated polymers can be any one of FEP, MFA, PFA, ECTFE and PTFE; the sheath 11, 111 is in turn constituted by an internal substrate 14, 114 made of a non-pigmented virgin material, and by an external substrate 15, 115 made of pigmented material, preferably, but not exclusively, white.

The external substrate 15, 115 of the sheath 11, 111, which is cemented by way of a chemical process that renders the fluorinated polymer bondable by adhesive to other surfaces, and the innermost intermediate reinforcement layer 12, 112, are coupled stably by way of the interposition of a layer of rubber 16, 116.

The covering layer 13, 113 is made of rubber.

The intermediate reinforcement layers 12 comprise, in a first embodiment, at least one first textile reinforcement layer 17, and in particular they comprise a first and a second textile reinforcement layers 17, 18 with the interposition of a filler layer 19 made of elastomeric material.

The first and the second textile reinforcement layers 17, 18 are made, by way of example, of PET polyester or aramid fabric.

The filler layer 19 of elastomeric material is made, advantageously, of rubber.

The intermediate reinforcement layers 112 comprise, in a second embodiment, at least a first textile reinforcement layer 117 and in particular they comprise a first and a second textile reinforcement layers 117, 118, with the interposition of a filler layer 119 made of elastomeric material, coaxially to which a reinforcement spiral 120 is stably wound and associated, with variable inclination and pitch according to the applicative and productive requirements.

The first and the second textile reinforcement layers 117, 118 are made, by way of example, of PET polyester or of aramid fabric.

The filler layer 119 of elastomeric material is made, advantageously, of rubber.

The optional reinforcement spiral 120 is made of metallic material, such as for example carbon steel, galvanized or stainless. Alternatively such reinforcement spiral 120 is made of a thermoplastic material.

The choice of material, the arrangement and the number of helices can vary and depend on the production technology, on the type of characteristics sought and on the type of performance required from the tube.

Thus it has been found that the disclosure fully achieves the intended advantages by providing a multilayer tube 10, 110, particularly for fluids, having been obtained which makes it possible to preserve and maintain the characteristics of the fluid that flows inside it by virtue of the fact that between the fluid and the pigmented external substrate 15, 115 is interposed the internal substrate 14, 114, made of non-pigmented virgin fluorinated polymer such as FEP, MFA, PFA, ECTFE and PTFE, which prevents any contamination of the fluid by the substances used for the pigmentation of the external substrate 15, 115.

It has further been observed that the multilayer tube is flexible, a tube having been obtained that has a sheath with a contained overall thickness that advantageously allows the tube to bend.

It has further been found that the multilayer tube has a good visual impact by virtue of the fact that the sheath 11, 111 is constituted by an external substrate 15, 115, made of fluorinated polymer such as FEP, MFA, PFA, ECTFE and PTFE which is pigmented, preferably advantageously white; the user who has to inspect the inside of the tube will therefore see the uniformly white color of the external substrate 15, 115 which will obscure the color of the layer of cement above it.

The disclosure is susceptible of numerous modifications and variations.

Obviously the materials used as well as the dimensions of the individual components of the disclosure may be more relevant according to specific requirements.

The characteristics indicated above as advantageous, convenient or the like, may also be missing or be substituted by equivalent characteristics.

1. A multilayer tube, provided with an internally hollow shape, the multilayer tube comprising a co-extruded sheath made of fluorinated polymers, located in the innermost layer and constituted by an internal substrate made of non-pigmented virgin material and by an external substrate made of pigmented material.

2. The tube according to claim 1, wherein said fluorinated polymers are constituted by any one of FEP, MFA, PFA, ECTFE, and PTFE.

3. The multilayer tube according to claim 1, wherein said multilayer tube is constituted by said sheath, which is adapted to be placed in direct contact with a fluid in transit, by one or more intermediate reinforcement layers, which are arranged coaxial to said sheath, and by an external covering layer, which is made of elastomeric material and is coaxial to said one or more intermediate reinforcement layers.

4. The multilayer tube according to claim 3, wherein said external substrate of said sheath, which is cemented by way of a chemical process that renders the fluorinated polymer bondable by adhesive to other surfaces, and an innermost layer of said one or more intermediate reinforcement layers are coupled stably by way of the interposition of a layer of rubber.

5. The multilayer tube according to claim 3, wherein said intermediate reinforcement layers comprise at least a first textile reinforcement layer.

6. The multilayer tube according to claim 3, wherein said intermediate reinforcement layers comprise at least a first textile reinforcement layer and a second textile reinforcement layer, with the interposition of a filler layer made of elastomeric material.

7. The multilayer tube according to claim 3, wherein said intermediate reinforcement layers comprise said first and said second textile reinforcement layers with the interposition of a filler layer made of elastomeric material, coaxially to which one or more reinforcement spirals, made of metallic or thermoplastic material, are stably wound and associated.
